(19) United States
(12) Patent Application Publication
(10) Pub. No.: US 2009/0251607 A1
(43) Pub. Date: Oct. 8, 2009

(54) DISPLAYING PRESENTATIONS

(75) Inventors: James A. Stoddart, Cumming, GA (US); Gary E. Webb, Cumming, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: SLIDESHOW TECHNOLOGIES, INC., Cuming, GA (US)

(21) Appl. No.: 12/417,227

(22) Filed: Apr. 2, 2009

Related U.S. Application Data
(60) Provisional application No. 61/042,159, filed on Apr. 3, 2008.
(60) Provisional application No. 61/119,055, filed on Dec. 2, 2008.
(60) Provisional application No. 61/151,227, filed on Feb. 10, 2009.

(51) Int. Cl. H04N 3/27

(52) U.S. Cl. 348/554; 348/E03.049

(57) ABSTRACT

Included are embodiments of a mobile presentation device. At least one embodiment of the device includes a memory device including at least one file; and a processing component coupled to the memory device, the processing component configured to, upon activation of the presentation device, automatically determine whether the at least one file is a compatible file and, in response to determining that the at least one file is a compatible file, automatically convert the at least one file into a sequence of signals that is sent for display as a presentation that includes at least one viewable image.

### CROSS REFERENCE

This application claims the benefit of U.S. Provisional Application No. 61/042,159, filed Apr. 3, 2008, U.S. Provisional Application No. 61/119,055, filed Dec. 2, 2008, U.S. Provisional Patent Application No. 61/151,227, filed Feb. 10, 2009, all of which are hereby incorporated by reference in their entireties.

### BACKGROUND

In many business and personal settings, users make presentations with a projector or other display device. The presentations often involve coupling a personal computer with a projector. While such configurations may provide the presentation data to the desired audience, these configurations often do not allow presentation of the data without setup problems. Additionally, utilizing a personal computer can be cumbersome. Further, such configurations do not easily allow for sophisticated display of the presentation with plurality of display devices. Thus, a heretofore unaddressed need exists in the industry to address the aforementioned deficiencies and inadequacies.

### SUMMARY

Included are embodiments a mobile presentation device. At least one embodiment of the device includes a memory device including at least one file; and a processing component coupled to the memory device, the processing component configured to, upon activation of the presentation device, automatically determine whether the at least one file is a compatible file and, in response to determining that the at least one file is a compatible file, automatically convert the at least one file into a sequence of signals that is sent for display as a presentation that includes at least one viewable image.

Other embodiments and/or advantages of this disclosure will be or may become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

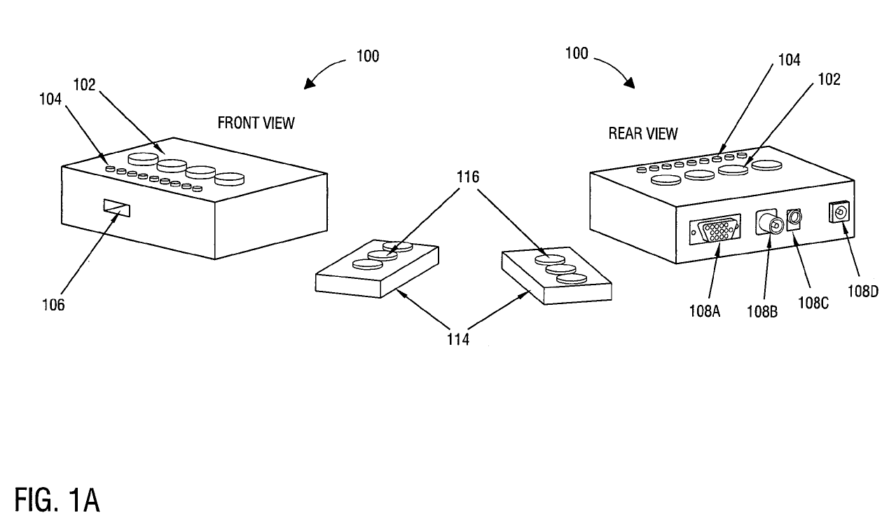

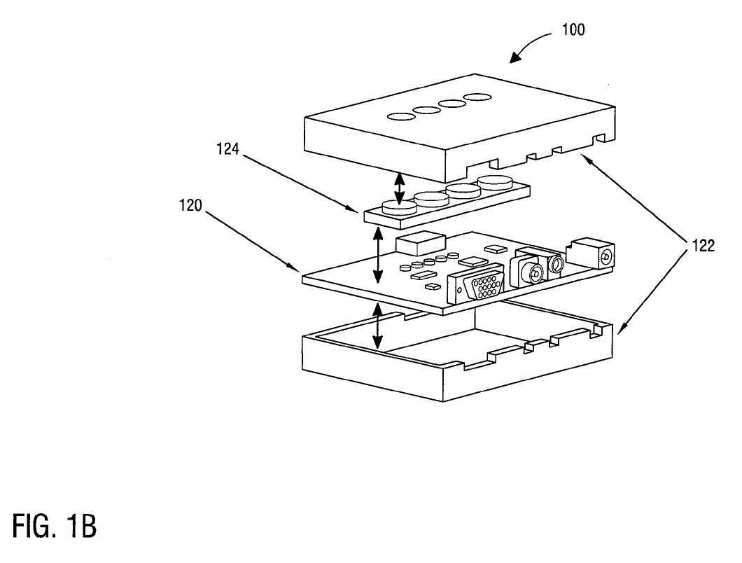

FIG. 1A illustrates an exemplary embodiment of a presentation device and remote control.

FIG. 1B illustrates another exemplary embodiment of the presentation device, similar to the diagram from FIG. 1A.

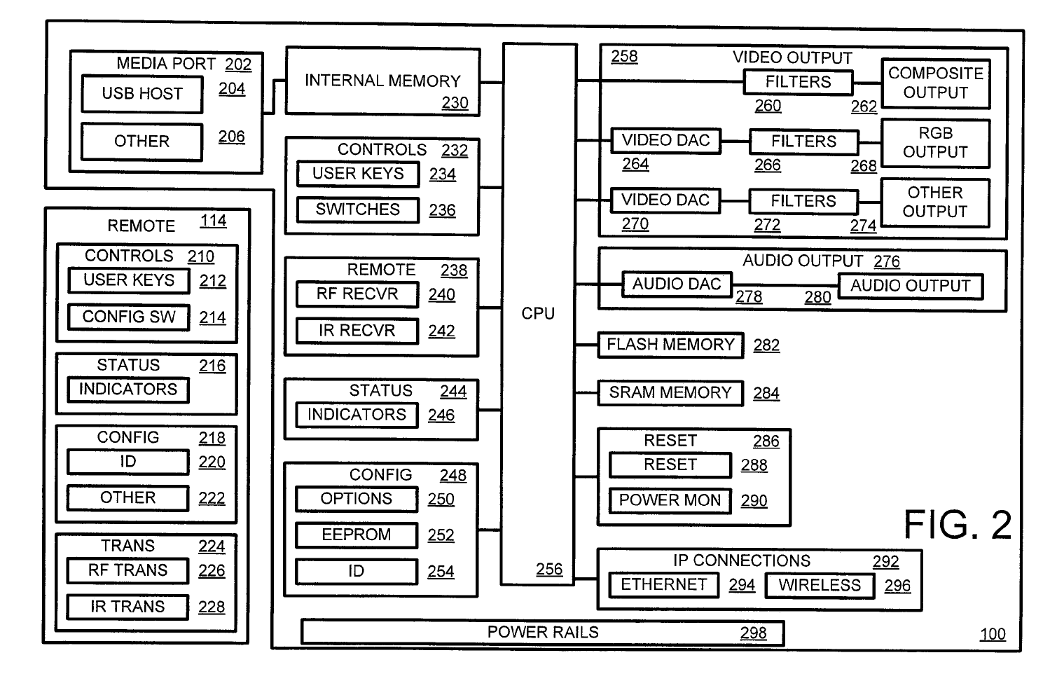

FIG. 2 illustrates an exemplary block diagram, further illustrating internal components of the presentation device from FIGS. 1A and 1B.

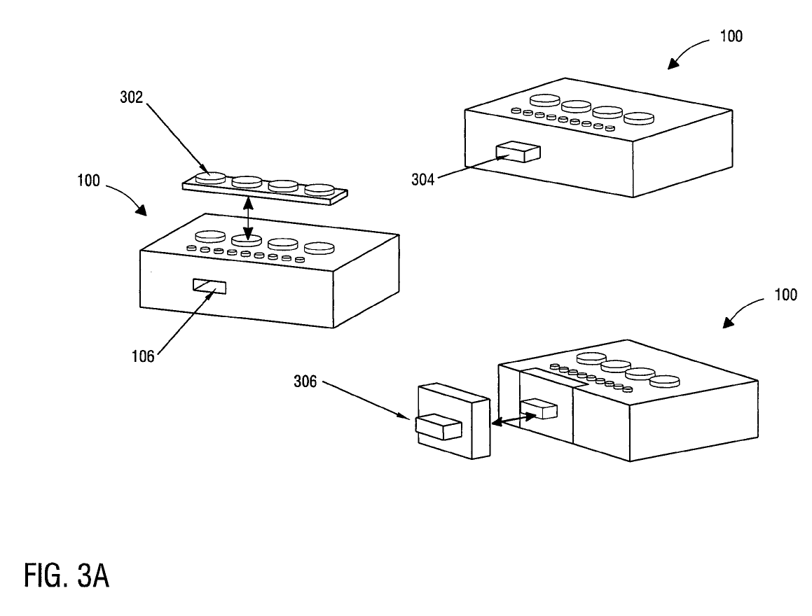

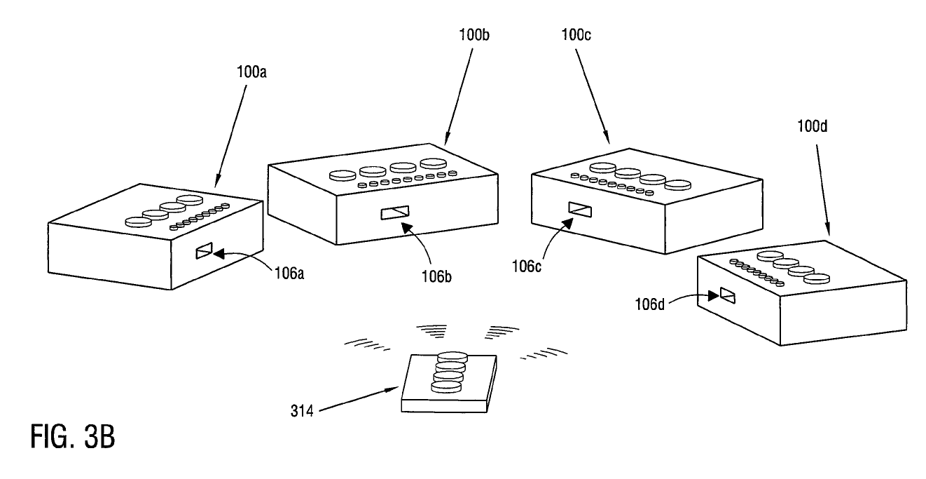

FIG. 3A illustrates another nonlimiting example the presentation device from FIGS. 1A and 1B.

FIG. 3B illustrates a nonlimiting example of a configuration that utilizes a plurality of presentations devices, such as the presentation device from FIG. 1A and 1B.

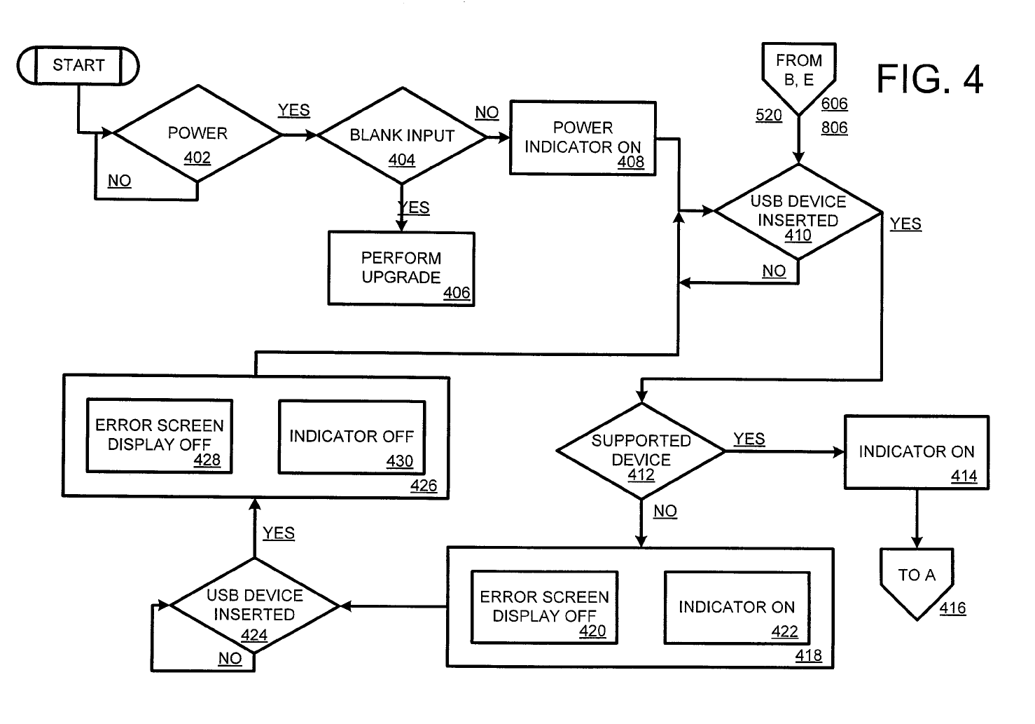

FIG. 4 illustrates an exemplary flowchart for a start-up sequence that may be utilized by a presentation device, such as the presentation device from FIGS. 1A and 1B.

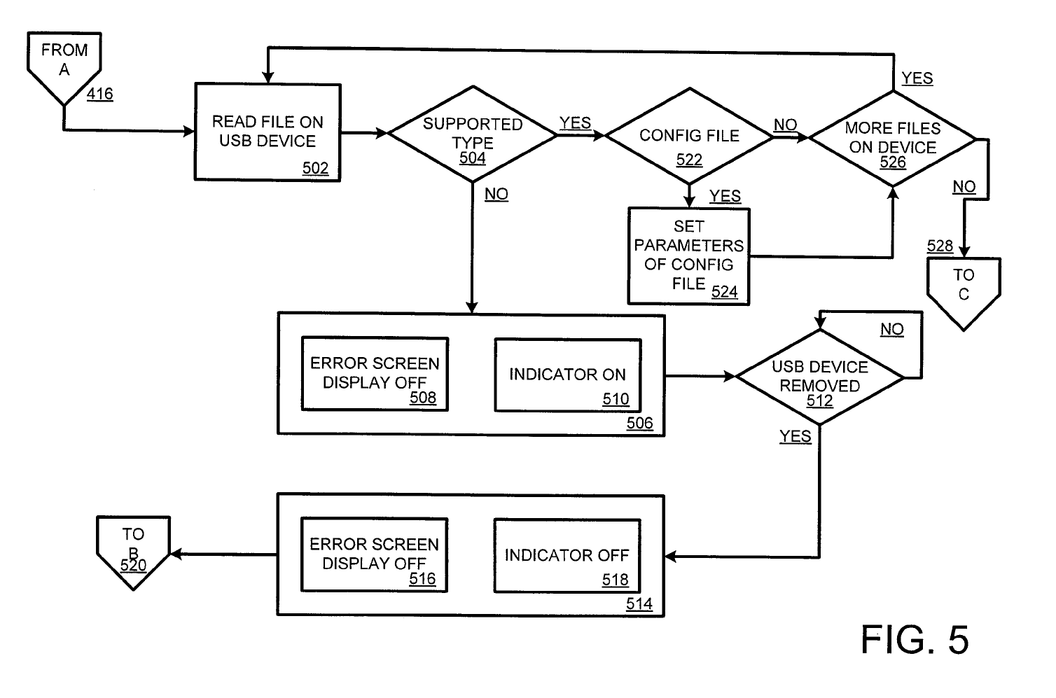

FIG. 5 illustrates an exemplary flowchart for querying an attached memory device, similar to the diagram from FIG. 4.

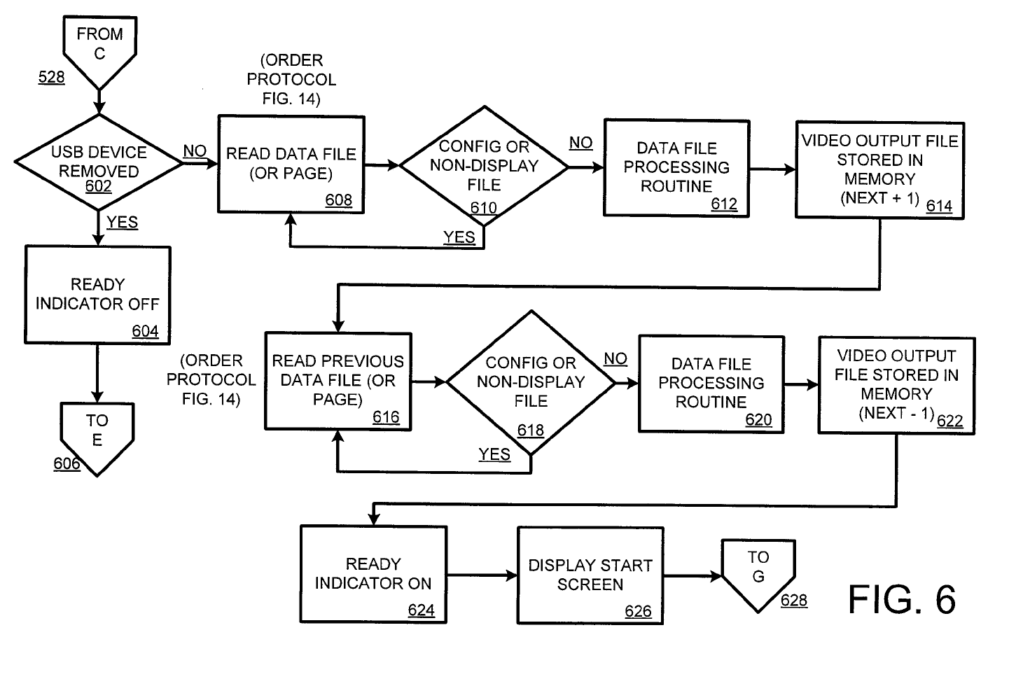

FIG. 6 illustrates an exemplary flowchart for an initial buffering of video output files, similar to the diagram from FIG. 5.

FIG. 7 is an exemplary flowchart for processing of data files, similar to the diagram from FIG. 6.

FIG. 8 illustrates an exemplary flowchart describing one or more responses of the presentation device to user inputs, similar to the diagram from FIG. 7.

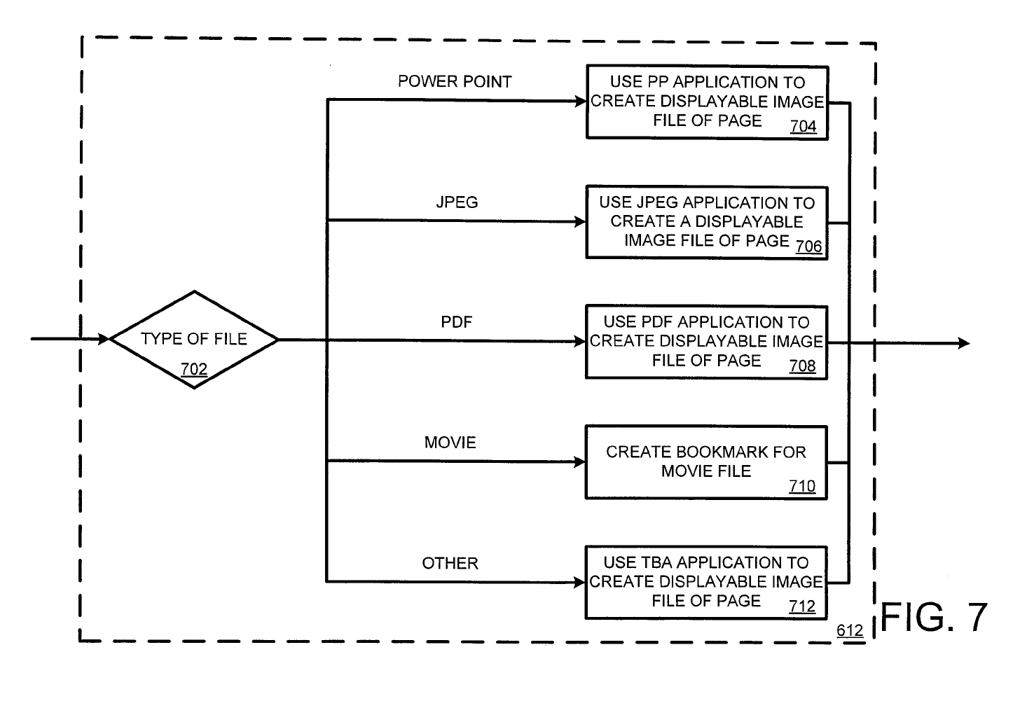

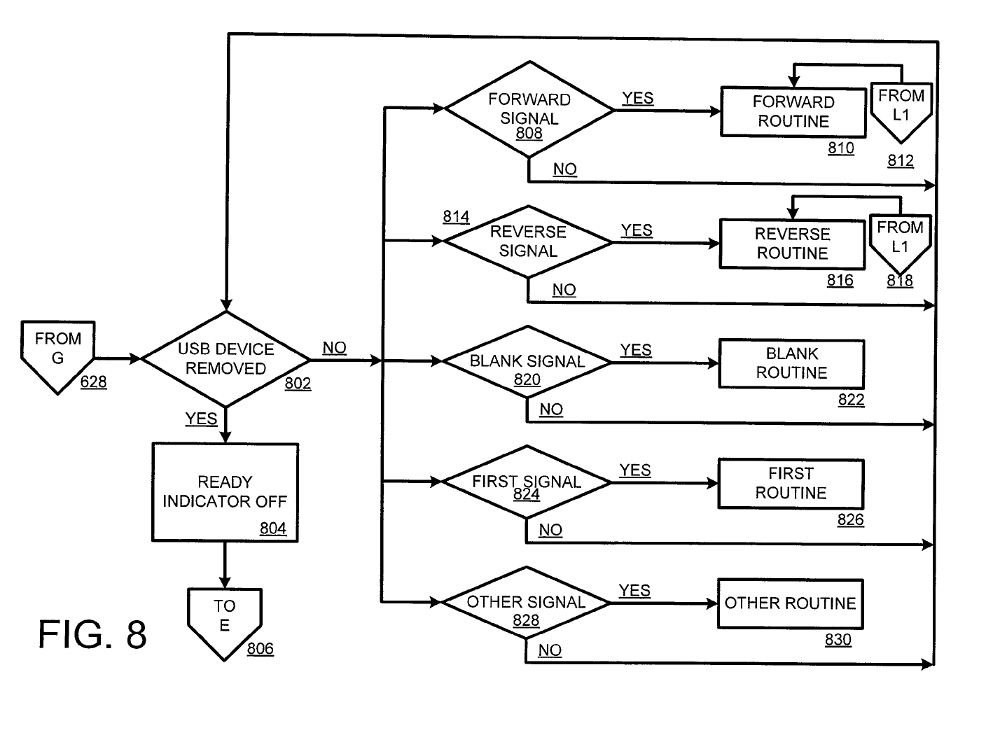

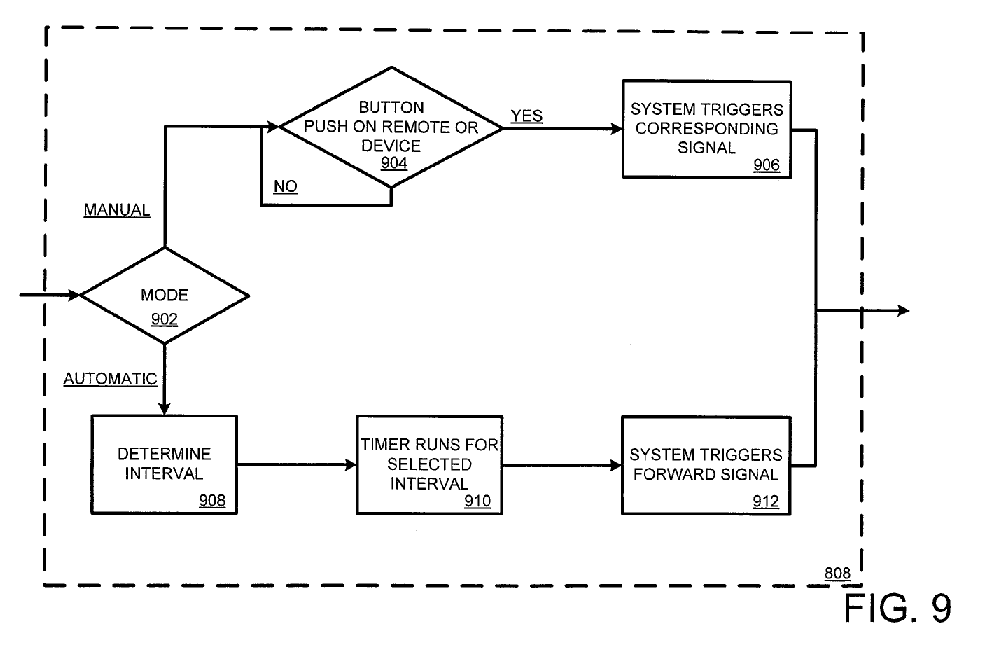

FIG. 9 illustrates an exemplary flowchart for manual and automatic operation modes of the presentation device, similar to the diagram from FIG. 8.

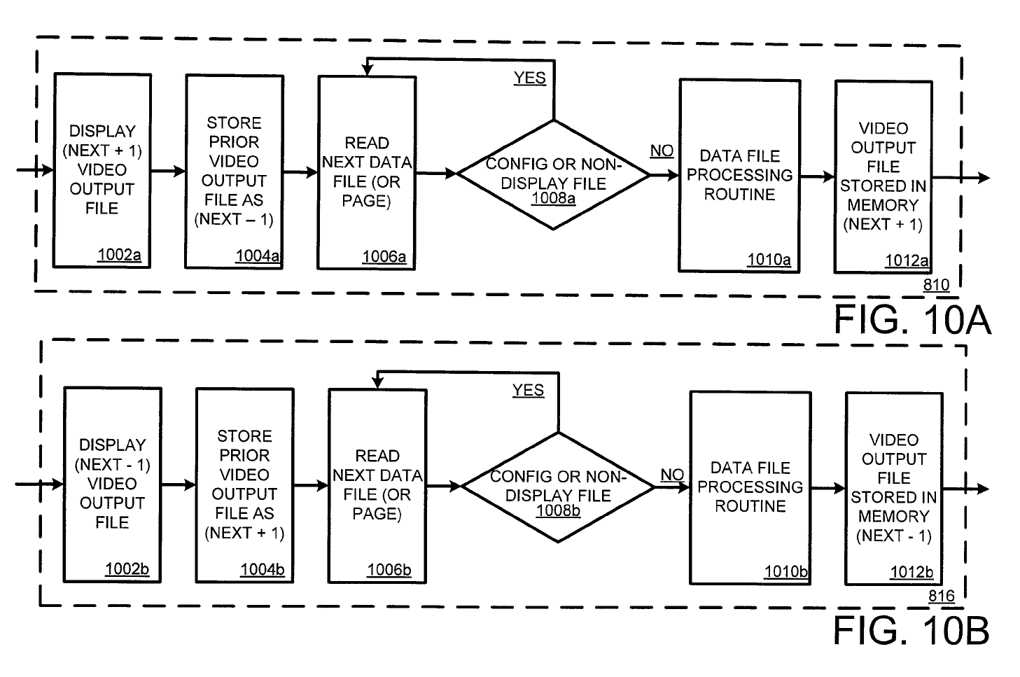

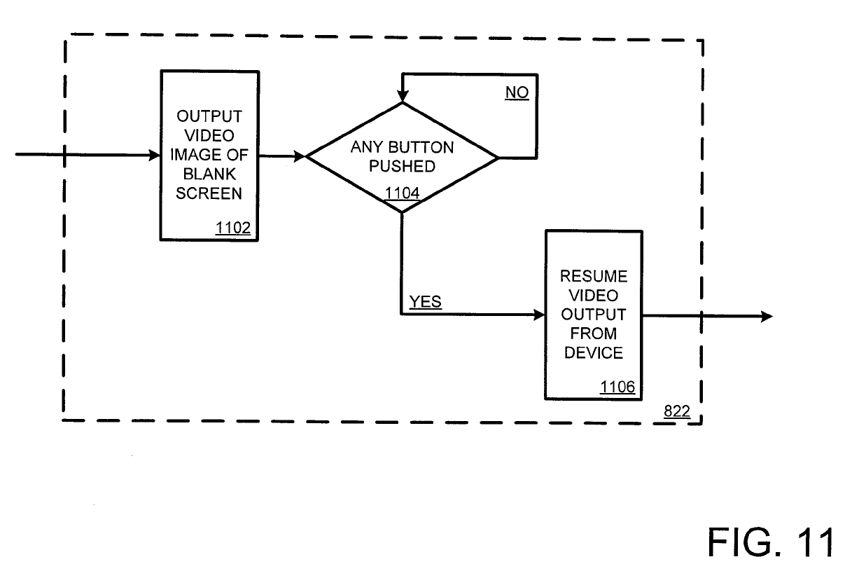

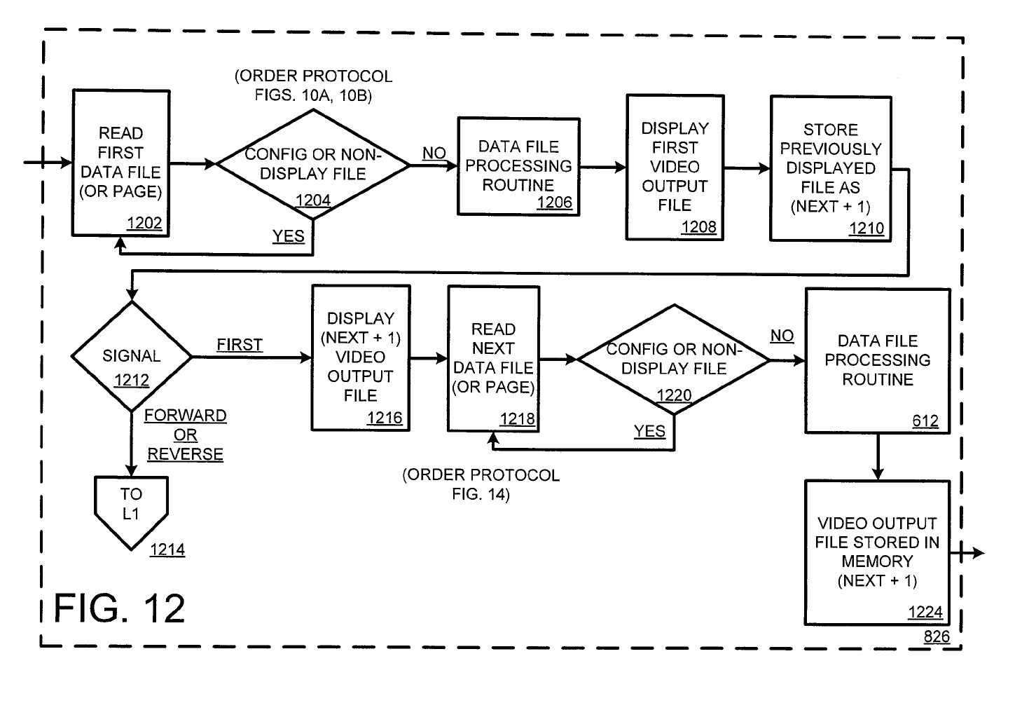

FIGS. 10A and 10B illustrate exemplary flowcharts for the presentation device to sequence images, similar to the diagram from FIG. 9.

FIG. 11 illustrates an exemplary flowchart for utilizing a blank function on the presentation device, similar to the diagram from FIGS. 10A and 10B.

FIG. 12 illustrates an exemplary flowchart for utilization of a first slide function on the presentation device, similar to the diagram from FIG. 11.

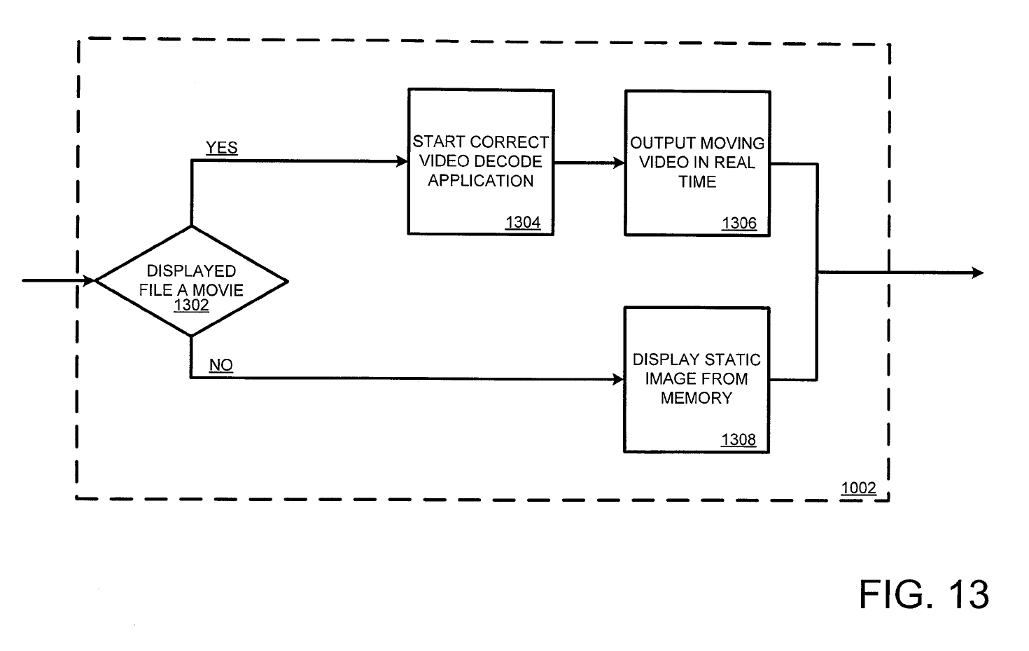

FIG. 13 illustrates an exemplary flowchart for processing images into a video output of the presentation device, similar to the diagram from FIG. 12.

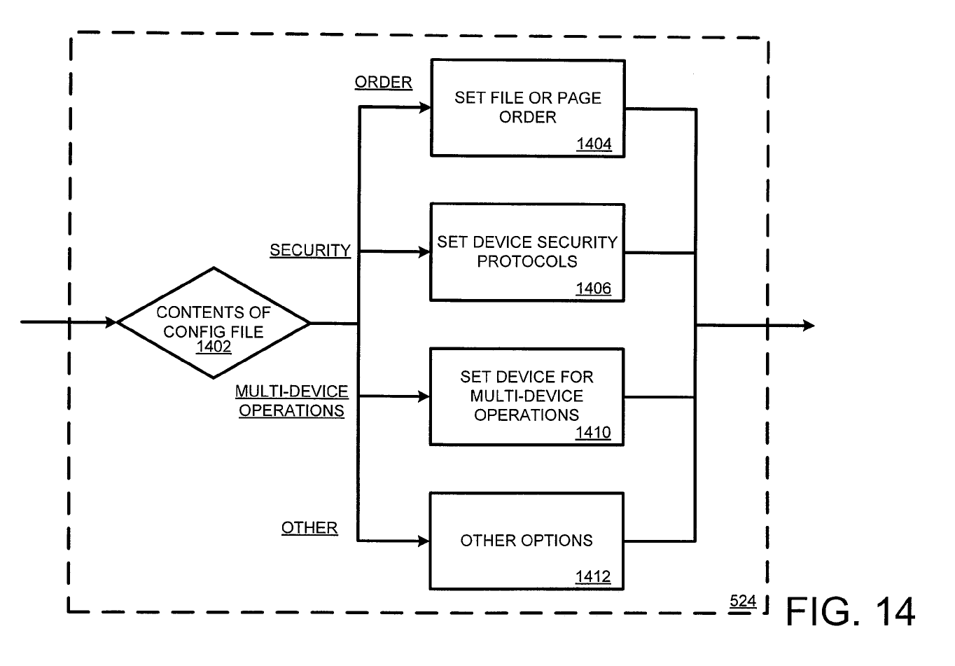

FIG. 14 illustrates an exemplary flowchart for configuration file processing with the presentation device, similar to the diagram from FIG. 13.

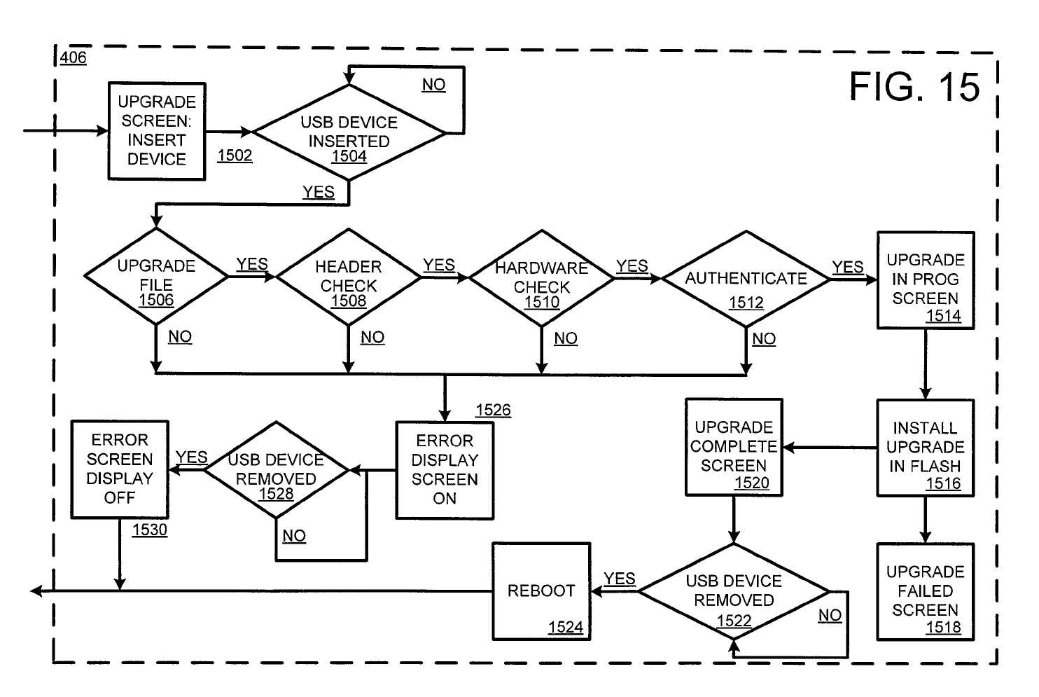

FIG. 15 illustrates an exemplary flowchart of a software update function that may be utilized on the presentation device, similar to the diagram from FIG. 14.

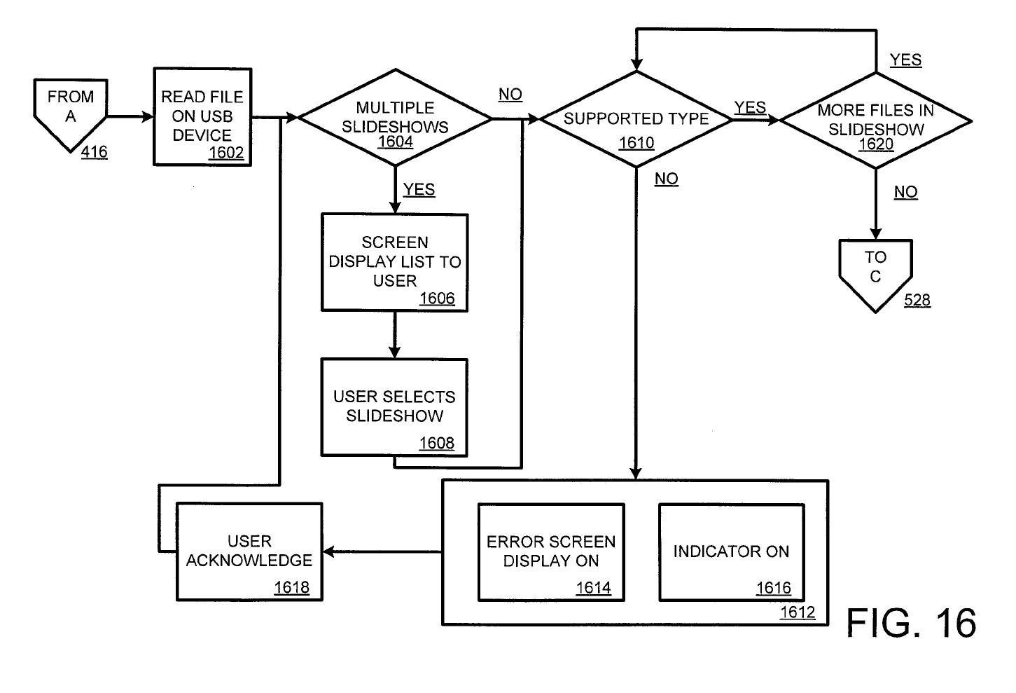

FIG. 16 illustrates an exemplary flowchart for providing a plurality of presentations with a common memory device, similar to the diagram from FIG. 15.

### DETAILED DESCRIPTION

Embodiments described herein provide methods and systems for the display of presentation materials, images, documents and/or full motion video content via a display device, such as a projector or display monitor. At least some of the systems disclosed herein include embodiments of a small portable presentation device that may be removably coupled to the display device. As described in more detail below, the presentation device may be configured to receive and/or store a presentation as a plurality of discrete files and provide at least one viewable image (e.g., still images, video images, etc.) and/or audio of those files as a sequential presentation. Additionally, in some embodiments, the presentation device may be permanently coupled to another device, such as a computer projection device. Similarly, in some embodiments, the presentation device includes a plurality of files in different formats and the presentation device is configured to provide the files for display in a format that provides for a seamless transition between the files. Other embodiments are also contemplated, as discussed below.

With regard to the drawings, FIG. 1A illustrates a perspective view of an exemplary embodiment of a presentation device 100 and remote control unit 114. As illustrated, the presentation device 100 includes user input devices 102, which could take the form of push buttons, switches, etc. The input devices 102 may be configured to provide a user with one or more options for performing various functions. As a nonlimiting example, a first input may be configured to cause the presentation device 100 to advance to a next output slide. A second input may be configured to cause the presentation device 100 to advance to a previous output slide. Similarly, a third input may be configured to cause the presentation device to cause the output device to toggle between an on position and an off position, producing a blank screen effect. A fourth input may be configured to cause the presentation device 100 to return to the first output slide of the presentation.

Additional options may also be provided with the presentation device 100. More specifically, the presentation device 100 may be configured to provide one or more options for selection of an automatic or manual mode. In the manual mode, the presentation device 100 may respond to user inputs only. However, the automatic mode may be configured to allow the presentation device 100 to automatically perform a sequence of actions with no user input. Other options may also be included, such as an output display option for changing pixel resolution of the output image.

As also illustrated in FIG. 1A, the presentation device 100 may include one or more indicators 104 for providing status information of the presentation device 100. The indicators 104 may be configured as light emitting diodes (LEDs); however this is a nonlimiting example. Similarly, the presentation device 100 may also include a port 106, where an external storage device (such as a memory device) may be coupled to the presentation device 100. The storage device may be configured as a universal serial bus (USB) flash drive, a compact flash memory card, a portable hard drive, a proprietary storage device and/or other type of storage device.

The presentation device 100 may also include one or more connections 108a-108d to provide an interface for the output of video and/or audio signals to an external display device such as a projector or digital monitor. The connections 108 may include a composite video connection, a component video connection, a red green blue (RGB) video connection (as a nonlimiting example with a video graphics array (VGA) style connector), a high definition media interface (HDMI) video connection, and/or other connections.

The connections 108a-108d may also include audio connections. As a nonlimiting example, the connections may be configured for coupling to an amplification device such as speakers, sound systems integral to projectors or monitors, and/or an audio amplifier. These connections may take any of a plurality of forms, such as radio corporation of America (RCA) style connectors, audio jacks, mini-plugs, and/or other audio connectors.

As also illustrated in FIG. 1A, the presentation device 100 may be associated with a remote control unit 114 that may include one or more input controls 116, through which a user can control the presentation device 100 to perform various functions, such as those described above. Additionally, in some embodiments, the remote control unit 114 may be configured to receive presentation advancement data associated with a presentation. More specifically, in such embodiments, the remote control device 114 may receive the advancement data (and/or identifiers associated with the corresponding presentation device 100) for the current presentation. The data may be received via a wired coupling with a personal computer and/or via a wireless connection (e.g., wireless fidelity (Wi-Fi), WiMax, etc.) to a computer that sends the advancement data and device identifiers.

FIG. 1B illustrates another perspective view of an exemplary embodiment of the presentation device 100, similar to the diagram from FIG. 1A. One or more circuit boards 120 may be housed within an enclosure 122. As a nonlimiting example, the enclosure may be configured as a two piece molded assembly which fits around the electronic board, or could be in the form of an extrusion that the board slides into. The presentation device 100 may also include one or more assemblies 124, which form a user interface. Such assemblies may include membrane switches, individual switches, capacitive switches, slide switches, and/or other components.

FIG. 2 illustrates an exemplary block diagram of a plurality of internal components of the presentation device 100 from FIGS. 1A and 1B. As illustrated, a processor 256 (such as an advanced risk machine (ARM)/digital signal processing (DSP) graphics co-processor, central processing unit (CPU), etc.) reads input files, user inputs and other inputs, and outputs graphics files and other associated data.

A media port 202 may be coupled to the processor, either directly (in the embodiments where the presentation device 100 does not include an internal memory component 230) or indirectly (where the presentation device 100 does include an internal memory component 230). In the exemplary embodiments where the presentation device 100 includes an internal memory component 230, the internal memory component 230 may be directly coupled to the processor 256 and the media port 202 may be directly coupled to the internal memory component 230. The media port may include a USB host 204 and/or other hosts 206.

A controls component 232, which may include user keys 234 and/or switches may 236 be coupled to the processor 256. A remote receiver component 238 may be included as part of the presentation device 100 and coupled to the processor 256. The receiver component may include a radio frequency (FR) receiver 240 and/or an infrared (IR) receiver 242. The remote receiver component 238 may be configured to receive and decode signals from the remote control unit 114 (from FIG. 1A) to control one or more operations of the presentation device 100. A status component 244 may be coupled to the processor 256, which may include one or more indicators 246 (similar to the indicators 104, from FIG. 1A). Similarly, a configuration component 248 may be coupled to the processor 256 to control device configuration, such as an options component 250, an EEPROM memory 252 containing configuration information or a device containing an ID 254. One or more flash memory devices 282 may be included and coupled to the processor 256. The flash memory 282 may contain “embedded” software systems that may be used by the presentation device 100 to perform one or more functions. This embedded software system may be factory loaded; however this is not a requirement. The embedded software system may be built on a standard operating system (such as Linux or Windows CE), and/or could be written as a stand alone system. Similarly, presentation device 100 may include one or more SRAM memory devices 284. The SRAM memory device may be coupled to the processor 256 and configured to provide operational memory for processing or buffering images.

A video output component 258 may also be included and coupled to an output of the processor. The video output component 258 may be configured to provide video signals to external devices (such as a display device). More specifically, in some exemplary embodiments, the video output includes one or more filters 260 that are coupled to a composite output 262. Similarly, some embodiments include a video digital to analog converter (DAC) 264, one or more filters 266, and an RGB output 268. Still some embodiments may be configured with a video DAC 270, one or more filters 272, and one or more other outputs 274.

In operation, output from the processor 256 may be filtered and terminated at an output connection terminal (such as at composite output 262). Similarly, in some embodiments, output from the processor 256 may be input to one or more electronic video components (such as a DAC 264), which convert the form of the video output, scale the form of the video output or modify the video output in some other way.

An audio output component 276 may also be included and coupled an output of the processor 256 and include an audio DAC 278 and an audio output 280. The audio output component 276 may be configured to provide audio signals to external devices, as a nonlimiting example via a RCA-type connector and/or an audio jack. Output from the processor 256 may be filtered and terminated at an output connection terminal. Similarly, in some exemplary embodiments, output from the processor 256 may be input to certain specialized components (such as an Audio Digital to Analog Converter), which convert the form of the audio output or modify the audio output in some other way.

Also included in the presentation device 100 of FIG. 2 is a reset component 286. The reset component 286 may include a reset device 288 to reset an operating system of the presentation device 100. Similarly, the reset component 286 may include a power monitor component 290 for monitoring and/or managing power of the presentation device 100.

Additionally, the processor 256 may be coupled to an Internet protocol (IP) connections component 292 that operates as an interface to other devices via a local area network, a wide area network, and/or the Internet. This would allow the presentation device 100 to receive inputs and/or send outputs via a network connection. Such a network connection may take the form of a wired connection (such as an Ethernet connection) and/or a wireless connection (such as a wireless fidelity (Wi-Fi) connection and/or a Bluetooth connection).

Also included in the exemplary embodiment of FIG. 2, the presentation device 100 may be powered by a set of one or more power rails 298 that connect to power inputs of the electronic components. The power rails 298 may be configured to receive power from an external power source, such as a power cord and/or voltage converter. Similarly, the power rails 298 may be configured to receive power from an internal power source, such as internally mounted replaceable batteries and/or an internal rechargeable battery.

Additionally included is the remote control unit 114, which may be configured to wirelessly communicate to the presentation device 100. The remote control unit 114 may include controls component 210, which may include one or more user keys 212 and a configuration software component 214. In operation, the remote control unit 114 may be configured to transmit one or more instructions to the presentation device 100 utilizing a transmitter 224, such as an RF transmitter 226 and/or an IR transmitter 228. The remote control unit 114 may also include a configuration component that includes a unique identification component 220 and/or other components for identifying the remote control unit 114. The remote control unit 114 may also include one or more status indicators 216 to provide status information of the remote control unit 114 and/or the remote operations.

Additionally, in some embodiments, the remote control unit 114 may include a memory component for storing identification data for one or more presentation devices 100 and a processor for executing instructions from the memory component. Further, in some embodiments, the remote control unit 114 may include a network port (wireless and/or wired) for communicating with remote computers to receive presentation advancement data, presentation device 100 identification data, and/or other data.

One should also know that in some exemplary embodiments, the processor 256 may also include a transmitter. In such embodiments, the remote control unit 114 may include a receiver, such that the presentation device 100 sends data signals to the remote control unit 114.

FIG. 3A illustrates another nonlimiting example of the presentation device 100 from FIGS. 1A and 1B. As illustrated in the nonlimiting example of FIG. 3A, the remote control unit 114 may be configured as a detachable portion of the presentation device 100. Not only may this provide a convenient method of transporting the remote, such a configuration may also allow the remote to act as a user interface on the presentation device 100, when attached to the presentation device 100.

Additionally, as also illustrated in FIG. 3A, the port 106 (FIG. 1A) may be configured to receive an external memory device and/or as a connector that can connect directly (or via a cable) to another device (such as a personal computer, laptop computer, etc.). As a nonlimiting example, to load a file into the presentation device 100, a user may connect the port 304 directly to their computer. In such a configuration the presentation device 100 may appear to be a memory device on the personal computer.

In some embodiments, the port 114 may be configured to receive a memory device 306. In these embodiments, the memory device 306 may be configured as a USB thumb drive, a proprietary memory unit, and/or other memory unit.

In operation, the user could connect the presentation device 100 to a display device, such as a projector or monitor, via a video (and/or audio) connection cable. The user may then insert a memory device 306, such as a USB flash drive or other portable memory device, into the port 106. The memory device 306 may contain one or more files for one or more slideshow presentations. More specifically, the files may include business presentation files (such as Adobe files, word processing files, Spreadsheet files, presentation files, such as PowerPoint files, Apple keynote files, Mathematica player files, open document presentation files, open xml presentation files, Lotus freelance graphics files, Staroffice starImpress files, Thinkfree show files, Corel presentations files, Songshow files, etc.—which are created with corresponding business presentation software), images, videos, audio files, .pdf files, document files, spreadsheet files, and/or other files. The files may be stored on the memory device 306 via a file transfer from a personal computer, laptop computer, etc. (e.g., by plugging in the memory device 306 into a USB port on the computer and dragging and dropping the files into the USB drive). The user can specify the order for the presentation by arranging the files in the desired presentation order. As a nonlimiting example, if the personal computer automatically sorts files by name, the user may rename the file on the memory device 306 (e.g., slide01.jpg, slide02.ppt, slide03, .wav, slide04.mpeg, etc.) such the files are presented in the desired order.

Upon storing the files in the desired order on the memory device 306, the user may couple (e.g., plug in) the memory device 306 with the presentation device 100. Upon powering on the presentation device 100, and without any user input, the presentation device 100 checks the files and queues them up for display according to the desired order. More specifically, upon powering on, the presentation device 100 may determine the first, second, third, etc. slides for buffering. The number of files that are buffered may be predetermined and/or determined based on size of the files and size of the buffer. Additionally, the presentation device 100 may automatically buffer the last, second to last, third to last, etc. files in the presentation. This allows the user to “loop” the presentation from the first slide to the last slide (or vice versa) with little or no delay. The user may the present individual slides of the slideshow presentation via the input devices 102 and/or via the remote control device 114 (FIGS. 1A, 2). One should note that, in at least one embodiment, buffering of files may facilitate seamless transition between files of the same or different formats.

One should note that, in at least one exemplary embodiment, the presentation device 100 may be configured to store a plurality of file types and still present the files in the desired order. As a nonlimiting example, if the user has a PowerPoint presentation, images, videos, and/or other files, the user can create the PowerPoint and, instead of having to integrate the images, videos, etc. into the PowerPoint, the user can simply leave these files as separate files. By arranging the order of the files on the memory device, the presentation device 100 will automatically provide the desired files for the presentation.

One should also note that by buffering one or more of the files, the presentation device 100 may automatically instantiate the corresponding application that automatically provides the next file for display. More specifically, if the first file is a .jpg file, the .jpg display application may automatically instantiate to provide the first file. Additionally, the second file may be a PowerPoint presentation (which may include one or more slides). The second slide may be buffered prior to the display of the first slide. Additionally, the application that automatically provides the PowerPoint slides may be instantiated such that upon advancing to the next file, the first slide of the PowerPoint presentation is presented without delay. One should also note that in at least one exemplary embodiment, all applications may be instantiated upon powering on the presentation device 100, thus precluding the desire to instantiate applications in this manner.

FIG. 3B illustrates a nonlimiting example of a configuration that utilizes a plurality of presentations devices 100, similar to the diagram from FIGS. 1A and 1B. As illustrated, the configuration of FIG. 3B includes a central remote control device 314 that may be configured to cause a plurality of presentation devices 100a-100d to operate in a synchronized fashion by transmitting instructions to a predetermined presentation device 100 (e.g., 100a) at preprogrammed time intervals, specified times, and/or under certain operational conditions. More specifically, in such configurations, the remote control unit 314 may be configured to receive identification information for each of the presentation devices 100a-100d. As discussed above, the identification information can be received via a wired coupling with a computer and/or via one or more signals received wirelessly from a remote location. Additionally, the remote control unit 314 may be configured to determine a desired sequence for all the presentation devices 100. The remote control unit 314 may then be configured to send trigger signals to the desired presentation devices 100a-100d to provide the desired presentation.

In operation, a user may plug a memory device 306 in each of the ports 106a-106d. The memory device 306 may be the same for all of the ports 106a-106d, but this is not a requirement. If one or more of the presentation devices 100a-100d include an internal memory component 230 (FIG. 2), the memory device may simply be used to upload presentation files to the internal memory component 230 and may be removed once complete. The memory device 306 may then be used in the next presentation device 100.

Additionally, the remote control unit 314 may be configured to receive configuration information that may include identification data for sending signals to each of the presentation devices 100a-100d, as well as a trigger sequence and timing for coordinating an order of slide advancement for the presentation on each of the presentation devices 100. As a nonlimiting example, the remote control unit 314 may include a port (e.g., similar to port 106) for coupling (wirelessly and/or wired) to a computer. The computer may include hardware and/or software for sending identifiers of the presentation devices 100a-100d to the remote control unit 314. Additionally, when interfaced with the computer, the configuration information (e.g., order, timing, etc.) may be sent to the remote control unit 314 for each of the presentation devices 100a-100d advance to a next image.

Upon providing the desired configuration information, the remote control unit 314 can store the settings. When a user starts the presentation in automatic mode, the remote control unit 314 can automatically advance through the presentation according to the predetermined slide advancement settings. Similarly, when the user starts the presentation in manual mode, the remote control unit 314 may send a trigger signal to the one or more predetermined presentation devices 100 to advance to the next output (previous output and/or other output) upon a user selection of one or more of the user inputs on the remote control device 314.

As a nonlimiting example, the first slide of a presentation may be an image that is displayed on all the presentation devices 100a-100d. However, the second slide may only change the display provided by presentation devices 100a and 100d. Consequently, by pressing a forward command on the remote control unit 314, a signal is only sent to presentation devices 100a and 100d.

Similarly, some embodiments of a multi-presentation device 100 system may be configured as a master-slave configuration. More specifically, if the user desires to coordinate a plurality presentation devices 100, the user may couple a first presentation device 100a to a computer. The user can then select (via the computer) the desired display settings for the presentation. The presentation device 100a can store the desired presentation data. When the presentation device 100a is coupled to a display device (and one or more of the other presentation devices 100b-100d are coupled to display devices), user selects an input on the remote control unit 314 (e.g., advance to the next slide/file). The first presentation device 100a may receive this signal, determine which of the presentation devices 100a-100d is included in the instruction, and send a trigger signal to those presentation devices 100b Additionally, if the presentation device 100a is included in the instruction, the presentation device 100a can also perform the desired operation.

FIG. 4 illustrates an exemplary flowchart for a start-up sequence that may be utilized by a presentation device 100, such as the presentation device 100 from FIGS. 1A and 1B. When power is applied to the presentation device 100 (e.g., the presentation device 100 is plugged in and/or turned on with a switch) (block 402), the presentation device 100 may then determine whether a blank button (or other button) is being selected (block 404). If so, a software upgrade routine may be executed (block 406 and described in more detail, below). If at block 404, the blank button is not depressed, the presentation device 100 will proceed with its normal start up sequence. More specifically, a power indicator (LED) may be turned on (block 408), providing the user with an indicator that power has been successfully applied. The presentation device 100 may then determine whether memory device 306 has been inserted into the port 106 on the presentation device 100 (block 410). This check may be performed in any of a plurality of ways, such as by invoking a software routine that exists in many operating systems, and/or as via an sensing that a device has been inserted. If the memory device 306 is not detected, the presentation device 100 continues searching (block 410). However, once the memory device 306 is detected, the presentation device 100 may determine whether the inserted memory device 306 is a supported device (block 412). If so, an indicator 106 may turn on, indicating that the memory device 306 is supported (block 414) and the process can proceed to jump block 416, continued in FIG. 5. If however, at block 412, a determination is made that the inserted memory device 306 is not supported, an error sequence may begin (block 418). The error sequence may include initiating the video output of an appropriate error screen (block 420) and/or turning on an appropriate error indicator 104 (block 422). The presentation device can continue to determine whether a supported memory device 306 is inserted (block 424). If not, the presentation device 100 continues to check (block 424). If however, the presentation device 100 detects a supported memory device 306, the error sequence may be terminated (block 426). Additionally, the error screen may turn off (block 428) and the indicator 106 may also turn off (block 426).

FIG. 5 illustrates an exemplary flowchart for querying an attached memory device, similar to the diagram from FIG. 4. When the memory device 306 is inserted into the presentation device 100, it is assumed that there is a plurality of files on the memory device 306. Each file may be tested to ensure every file is compatible with the presentation device 100 by examining file header information, and potentially performing other file tests.

More specifically, from jump block 416 (FIG. 4), the presentation device 100 reads the file on the memory device (block 502). The presentation device 100 may then determine whether the file is a supported type (block 504). If the file is not a supported type, an error sequence may begin (block 506), which may include initiating the video output of an appropriate error screen (block 508) and/or turning on an appropriate error indicator LED (block 510). The error sequence may be terminated when the memory device 306 with the unsupported file is removed (block 512). If the memory device 306 has not been removed, the process continues to check for removal (block 512). If however, the presentation device 100 determines that the memory device with the unsupported file has been removed, the presentation device may end the error signal (block 514). This may include turning the error screen display off (block 516) and/or turning the indicator off (block 518). The process may then move to jump block 520, continued in FIG. 4.

Returning to block 504, if it is determined that the memory device 306 includes only supported files, the presentation device 100 may determine whether the memory device 306 includes a configuration file (block 522). If so, the presentation device 100 can initiate a configuration file sequence (block 524). The presentation device 100 may then determine whether there are more files on the memory device 306 (block 526). If not, the process may proceed to jump block 528, continued in FIG. 6. If however, there are more files on the memory device 306, the presentation device 100 may return to block 502.

FIG. 6 illustrates an exemplary flowchart for an initial buffering of video output files, similar to the diagram from FIG. 5. More specifically, from jump block 528 (FIG. 5), the presentation device 100 may determine whether the memory device 306 has been removed (block 602). During this process, the presentation device 100 may repeatedly and/or continuously check if the memory device 306 has been removed. If so, the appropriate indicator 104 may be turned off (block 604), and the presentation device 100 operation may return to the power start-up sequence via jump block E (block 606), continued in FIG. 4.

If however, the presentation device 100 determines that the memory device 306 has not been removed (block 602), the presentation device 100 can begin buffering files on the memory device 306. More specifically, the presentation device 100 can read the first data file (block 608). As a side note, the first file (as well as the order of the data files for presentation) may be set by an order protocol established by a configuration file and/or may default to the order that the data files appear on the memory device 306. A determination can then be made regarding whether the first file is a configuration file or other non-displayable file (block 610). If the data file is a non-displayable file (such as a configuration file), the presentation device 100 may skip the non-displayable file and advance to the next data file, or the first page of the next data file (returning to block 608).

If the data file is not a non-displayable file, the presentation device 100 may process the file using a desired data file processing routine (block 612). As discussed in more detail below, the file processing routing may be selected based on the type of file. As a nonlimiting example, if the file is a .jpg file, a .jpg reader may be utilized to process the file. The resulting video output file may then be stored in a memory buffer as the “next” slide (block 614).

Similarly, the last data file is similarly read, analyzed and processed. More specifically, the last file may be read (block 616). A determination may then be made regarding whether the last file is a non-displayable file (block 618). If so, the process may return to block 616. If not, the last file may be processed by a desired data file processing routine (block 620). The video output file may be stored in the last memory slot (block 622).

Once both video output files are stored in memory, a ready indicator light turns on to let the user know that presentation is ready to show (block 624). Additionally, presentation device 100 may a video output by displaying a start screen (block 626). The start screen may include one or more graphics that allow the user to position and focus their projector or monitor before starting to show pages of their presentation. The process may then proceed to jump block G (block 628), continued in FIG. 8.

One should note that the buffering process described on FIG. 6 and similarly described in following figures may be expanded. More specifically, the presentation device 100 may be configured to pre-processes a plurality of files forward and a plurality of files file backward and store those video files in a buffer. These buffered video output files allow the device to respond to user commands more quickly. Depending on available memory available, additional forward slides and additional backwards slides could be buffered in memory.

FIG. 7 is an exemplary flowchart for processing of data files, similar to the diagram from FIG. 6. More specifically, FIG. 7 illustrates an expanded version of block 612, from FIG. 6. As illustrated, in processing the current file, the presentation device 100 may determine the type of file being processed (block 702). If it is determined that the file is a PowerPoint file, a PowerPoint application may be utilized to create a displayable image of the file (block 704). The PowerPoint application may be configured to automatically present the file in the desired format. Additionally, as discussed in more detail below, if the file is a PowerPoint file, the presentation device may be configured to cycle through the one or more slides of the PowerPoint file before proceeding to the next file on the memory device 306.

Additionally, the PowerPoint application (and/or other applications in FIG. 7) may be a routine built into the processor 256 (such as a special codec) of the presentation device 100, and/or be an application contained in the embedded software system (e.g., memory 282, 284).

Returning to FIG. 7, if the presentation device 100 determines that the file is a jpeg file, a jpeg application may be used to create a displayable image file (block 706). Similarly, if the file is a pdf file, a pdf application may be used to create a displayable image file (block 708). If the file is a movie file (e.g., .mpeg, etc.), the presentation device may create a bookmark for the movie file. If the presentation device 100 determines that the file is another supported file type, an appropriate application may be utilized to process the file (block 712).

One should note that in some exemplary embodiments, the presentation device 100 is configured to adding and/or amending the supported file types. More specifically, while the presentation device 100 may be factory shipped with no supported file types and/or a predetermined number (nonzero) of file types, the user may update the presentation device to change the supported file types. This may be desirable when new file types are developed and/or when a particular presentation utilizes one or more file types not previously utilized. Additionally, the updating of supported file types may occur via a user coupling the presentation device 100 to a computer and actively selecting associated plugins to support the desired file types. Similarly, some embodiments may be configured such that upon receiving the memory device 306, the presentation device 100 determines whether any of the files are not supported and, if so, alerts the user and/or automatically downloads the corresponding plugins.

FIG. 8 illustrates an exemplary flowchart describing one or more responses of the presentation device 100 to user inputs, similar to the diagram from FIG. 7. Continued from jump block G (block 628 from FIG. 6), the presentation device 100 can determine whether memory device 306 has been removed (block 802). As described previously, the presentation device 100 continues to monitor whether the memory device 306 has been removed. If it has, the ready indicator is turned off (block 804) and the presentation device 100 reverts back to the start-up sequence via jump block E (block 806, continued in FIG. 4).

If however, the presentation device determines that the memory device 306 has not been removed (block 802), the presentation device 100 may wait for one or more instructions (e.g., one or more user inputs and/or via normal cycling in automatic mode). Once the instruction is received, the presentation device 100 may begin the desired sequence. More specifically, the presentation device may determine whether a forward signal has been received (block 808). If so, the presentation device 100 may initiate a forward routine (block 810) to advance to a next slide in the presentation. Similarly, the forward routine may be initiated from jump block L1 (block 812).

If the presentation device 100 determines that a reverse signal is received (block 814), the presentation device 100 may initiate a reverse routine (block 816) to advance to the previous slide in the presentation. The reverse routine may be initiated from jump block L2 (block 818). If the presentation device determines that a blank signal is received (block 820), the presentation device may initiate a blank routine (block 822) to display a blank screen during the presentation. If the presentation device 100 determines that a “first” signal is received (block 824), a “first” routine may be initiated (block 826). If the presentation device 100 determines that another signal is received (block 828), a corresponding routing may be initiated (block 830).

FIG. 9 illustrates an exemplary flowchart for manual and automatic operation modes of the presentation device 100, similar to the diagram from FIG. 8. More specifically, FIG. 9 more explicitly illustrates block 808, from FIG. 8. As illustrated in FIG. 9, the forward signal could either be triggered manually (such as when the user pushes the forward button on the presentation device 100 or the remote control unit 114) or could be triggered automatically when the presentation device 100 is set for automatic operation (such as via a user input to a mode setting button or switch). More specifically, the presentation device may determine the current presentation mode (block 902).

If the presentation device 100 determines that the current operating mode is manual (block 902), the presentation device 100 can determine if a user input is received (block 904). If so, the presentation device 100 can trigger the corresponding signal (block 906). If on the other hand, the presentation device 100 is set for automatic operation (block 902), the presentation device 100 may determine an interval for advancing the presentation (block 908). The presentation device may set and run a timer for the selected interval (block 910). At the end of the selected interval, the presentation device may trigger a forward signal to advance the presentation (block 912).

FIGS. 10A and 10B illustrate exemplary flowcharts for the presentation device 100 to sequence images, similar to the diagram from FIG. 9. These sequences occur when the presentation device 100 receives a forward (FIG. 10A) or reverse (FIG. 10B) signal from a user input. More specifically, if the presentation device 100 receives a forward signal, the presentation device 100 can provide the video output file in the next+1 memory buffer position for display (1002a). The presentation device 100 can then store the prior video output in the next−1 buffer position (block 1004a). The next data file may then be read (block 1006a). A determination can be made whether the data file is a non-displayable file (block 1008a). If so, the presentation device 100 can read the next data file (block 1006a). If not, the presentation device 100 can initiate a data file processing routine (block 1010a). The video output file may then be displayed in memory position next+1 (block 1012a).

Similarly, if the presentation device 100 receives a reverse signal, (FIG. 10B), the presentation device 100 may output the video image stored in the next−1 memory buffer position (block 1002b). Similarly, the video image that was previously displayed is stored in the next+1 memory buffer position (block 1004b). The presentation device 100 can then read the previous data file (block 1006b). The presentation device 100 may also determine whether the file is a non-displayable file (block 1008b). If so, the process returns to block 1006b. If the file is not a non-displayable file, a data file processing routine may be initiated (block 1010b). The presentation device 100 may then store the video image in the previous memory position (block 1012b). As noted earlier, the buffering process described in FIGS. 10A and 10B may be expanded. Depending on the memory available in the presentation device 100, additional video images could be stored in both the forward and reverse direction. This allows the presentation device 100 to respond more quickly to user input.

FIG. 11 illustrates an exemplary flowchart for utilizing a blank function on the presentation device 100, similar to the diagram from FIGS. 10A and 10B. More specifically, FIG. 11 illustrates block 822 from FIG. 8. As illustrated, in FIG. 11, if the blank signal is received (such as via a user pushing the blank button), the presentation device 100 may output the video image of a blank screen (block 1102). The presentation device 100 may then wait for any user input (block 1104). If input is received from the user, the presentation device 100 may resume outputting the previously displayed video image (block 1106). Additionally, in some embodiments, stopping the video output of the blank image might require a specific user input, such as another push of the blank button.

FIG. 12 illustrates an exemplary flowchart for utilization of a first slide function on the presentation device 100, similar to the diagram from FIG. 11. More specifically, the exemplary embodiment of FIG. 12 illustrates block 826, from FIG. 8 in more detail. As illustrated in FIG. 12, if the presentation device 100 receives a “first” signal as a result of a user input, the presentation device 100 may then read the first data file (block 1202). As described previously, the first data may be determined by default and/or via a special configuration file. If the file is a non-displaying file (block 1204), the next file may be read (block 1202). If however, the file is not a non-displaying file, the data file may be processed into a video image using a desired processing routine (block 1206), as described in FIG. 7. The presentation device 100 may then begin outputting the video image of the first data file (block 1208). The video image that was previously displayed would be stored in the next+1 memory buffer position (block 1210). By doing this, it is possible for the user to quickly toggle back to that image by pressing the forward button again.

Specifically, if a forward and/or reverse signal is received, the process may proceed to jump block L1 (block 1214, continued in FIG. 8). If the signal is a forward signal, the process proceeds to jump block 812 (FIG. 8). If however, the signal is a reverse signal, the process proceeds to jump block 818 (FIG. 8). Similarly, if another “first” signal is received (block 1212), the presentation device 100 may output the video image that was stored in the next+1 memory position (block 1216). The presentation device 100 may then read the next file after the data file being displayed (block 1218). A determination may then be made regarding whether the file is a non-displaying file (block 1220). If so, the next file may be read (block 1218). If however, the file is a displayable file, the data file may be processed using the desired processing routine (block 612), as described in FIG. 7. Once processed, the video image of that data file may be stored in the next+1 memory position (block 1224). Effectively, this repopulates the images in buffer memory after a first button has been pushed. Similarly, if a forward or reverse signal followed a first signal, the presentation device 100 may advance images again starting with the first slide, using the processes such as those described in FIG. 8.

FIG. 13 illustrates an exemplary flowchart for processing images into a video output of the presentation device 100, similar to the diagram from FIG. 12. More specifically, FIG. 13 illustrates a more detailed view of block 1002, from FIG. 10. As illustrated in FIG. 13, the presentation device 100 may determine whether the displayed file is a movie (block 1302). If so, the presentation device 100 may start a corresponding video decoder application for the movie file (block 1304). As a nonlimiting example, if the file is an .mpeg file, an mpeg decoder application would be initiated. If the file is an .avi file, an .avi decoder application may be initiated. The decoded video may then be output in real time (block 1306). Similarly, if at block 1302, the presentation device 100 determines that the displayed file is not a movie, the static image may be provided from memory for display (block 1308).

FIG. 14 illustrates an exemplary flowchart for configuration file processing with the presentation device 100, similar to the diagram from FIG. 13. More specifically, FIG. 14 illustrates a detailed view of block 524, from FIG. 5. As discussed above, if the presentation device 100 reads a configuration file on the memory device 306, the presentation device 100 may initiate a process to utilize the information in the configuration file. As illustrated in FIG. 14, to facilitate this, the presentation device can determine the contents of the configuration file (block 1402). Configuration files may be text files that provide configuration instructions to the presentation device 100. If the presentation device 100 determines that the configuration file includes a desired data file order, the presentation device 100 may set the file order according to the configuration file (block 1404). Similarly, if the presentation device determines that configuration file includes data for configuring one or more security options, the presentation device 100 can set security protocols (block 1406). As a nonlimiting example, the configuration file may be configured to turn on a feature to place a watermark image and/or a serial number image on each video image that is output by the presentation device 100. Similarly, as another nonlimiting example, the configuration file may include an identification number to match with the built-in identifier of the presentation device 100. If the configuration file identification does not match the built-in identifier, the presentation device 100 may disable processing of data files on the memory device 306. Additionally, an error screen may be provided for display.

Additionally, if the presentation device 100 determines that the configuration file includes information to allow multi-unit information, the presentation device 100 can set the presentation device for multi-device operations (block 1410). As a nonlimiting example, the configuration file may include a sequencing ID for the presentation device 100. If the presentation device 100 receives a command from the remote control unit 314 that includes this sequencing ID, the presentation device can respond the command. Commands without the sequencing ID would be ignored by the presentation device 100.

Similarly, in a master-slave multi-device configuration, the configuration file may include identifiers for each presentation device 100a-100d and an indication of whether the presentation device 100 is a master or slave. This allows the master to send trigger signals to the slaves, based on the received presentation. Other options are also available (block 1412).

FIG. 15 illustrates an exemplary flowchart of a software update function that may be utilized on the presentation device 100, similar to the diagram from FIG. 14. More specifically, the embodiment of FIG. 15 illustrates a detailed view of block 406, from FIG. 4. As illustrated in FIG. 4, if the blank signal (or other specified signal or combination of signals) is received when the presentation device 100 is powering on (e.g., by the user holding down the blank button on the presentation device 100), the presentation device 100 may initiate a software upgrade routine and provide an upgrade screen that instructs the user to insert the memory device 306 (block 1502). Similarly, in some embodiments the presentation device 100 may be configured to automatically recognize that the memory device 306 includes an upgrade file, and automatically start the upgrade routine without any user input.

Once the upgrade routine is started, the presentation device 100 may determine whether the memory device 306 is inserted (block 1504). If so, the presentation device 100 may perform one or more checks on the data file. As a nonlimiting example, the presentation device may determine whether the memory device 306 includes an upgrade file (block 1506). If so, the presentation device 100 may check the header information on the file (block 1508). If the header is acceptable, the presentation device 100 can verify the hardware integrity of the presentation device 100 (block 1510). If the hardware is acceptable, the presentation device may authenticate the source of the upgrade file (block 1512). The upgrade routine could also verify whether the upgrade file on the USB memory device (or other memory device) had already been installed.

If the upgrade file does not pass one or more of these checks, the presentation device 100 may output a video image of an error screen (block 1526). A determination can then be made regarding whether the memory device 306 is removed (block 1528). When the memory device 306 is removed, the error screen may be turned off (block 1530), and the power sequence may restart. Similarly, in some embodiments, if the presentation device 100 finds that the data file(s) on the memory device 306 are display, the presentation device 100 could return the normal start-up sequence. This may simplify the user experience if buttons were pushed inadvertently while the presentation device 100 was being powered up).

Returning to FIG. 15, if the upgrade file passes all of the checks (blocks 1506-1512), the presentation device 100 can output an “upgrade in process” screen video image (block 1514). The presentation device 100 can then install the upgrade into flash memory 282. If the upgrade fails, a failed upgrade screen may be provided (block 1518). If however, the upgrade is completed, an upgrade complete screen may be provided (block 1520). This may also include a user instruction to remove the memory device 306. A determination may also be made regarding whether the memory device 306 is removed (block 1522). If so, the presentation device 1524 may reboot (block 1524). Additionally, in some embodiments, the upgrade routine may include protection, by not overwriting the original embedded software until the new embedded software upgrades have been fully installed and checked.

FIG. 16 illustrates an exemplary flowchart for providing a plurality of presentations with a common memory device, similar to the diagram from FIG. 15. More specifically, continuing from jump block A (block 416, FIG. 4), the process details actions to implement a plurality of presentation devices 100. From jump block A, the presentation device 100 can read a file from the memory device 306 (block 1602). The presentation device 100 can determine whether there are two or more slide shows on the memory device 306 (block 1604). As a nonlimiting example, the presentations may be contained in different folders or some other type of subdirectory on the memory device 306.

If the presentation device 100 discovers that there are multiple slideshow presentations on the memory device 306, the presentation device 100 can output a video image showing a list of the slideshow presentation files on the memory device 306 (block 1606). As a nonlimiting example, the list may include one or more names of folders or other subdirectories on the memory device 306. The presentation device may then determine whether the user selects one of the slideshows (block 1608). Once the user selects a sideshow (and/or if there is only one slideshow from block 1604), a determination can be made regarding whether a first file in the selected slideshow the file is supported (block 1610). If not, an error indicator may be provided (block 1612), which may include providing an error display screen (block 1614) and/or turning an error indicator on (block 1616). If however, the file is supported, the presentation device 100 can determine whether there are more files in the slideshow (block 1620). If so, the presentation analyzes the next file to determine if supported (block 1610). If all of the data files are supported, the presentation device 100 will proceed to jump block C (block 528, FIG. 6) to initiate the buffering process.

The embodiments disclosed herein can be implemented in hardware, software, firmware, or a combination thereof. At least one embodiment, disclosed herein is implemented in software and/or firmware that is stored in a memory and that is executed by a suitable instruction execution system. If implemented in hardware, as in an alternative embodiment embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. As a nonlimiting example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, as a nonlimiting example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A mobile presentation device comprising:
a memory device including at least one file; and
a processing component coupled to the memory device, the processing component configured to, upon activation of the presentation device, automatically determine whether the at least one file is a compatible file and, in response to determining that the at least one file is a compatible file, automatically convert the at least one file into a sequence of signals that is sent for display as a presentation that includes at least one viewable image.

2. The mobile presentation device of claim 1, the processing component further configured to, in response to a determination that the at least one file is not a compatible file, providing a sequence of signals representative of an error display.

3. The mobile presentation device of claim 1, the processing component further configured to determine whether the memory device includes a configuration file.

4. The mobile presentation device of claim 1, wherein the memory device includes a plurality of files, wherein each of the plurality of files is configured in a different format, and wherein the processing component is further configured to convert each of the plurality of files into a sequence of signals for presentation as a plurality of viewable images.

5. The mobile presentation device of claim 4, the processing device further configured to convert each of the plurality of files into the sequence of signals for display such that transition of display from a first file of the plurality of files to a second file of the plurality of files is seamless.

6. The mobile presentation device of claim 1, wherein the memory device is at least one of the following: removable and not removable.

7. A mobile presentation device comprising:
a port configured to receive a memory device, the memory device including a plurality of files, at least two of the plurality of files being configured in different formats; and
a processing component coupled to the port, the processing component configured to, upon activation of the presentation device, automatically convert the plurality of files from the different formats into a sequence of signals that is sent for display as a presentation that includes at least one viewable image.

8. The presentation device of claim 7, wherein the memory device includes at least one configuration file, the at least one configuration file configured to provide at least one of the following: a file order for the at least one presentation, at least one security protocol, and at least one parameter for multi-device operations.

9. The presentation device of claim 7, wherein at least one of the plurality of files is a business presentation file created with business presentation software and at least one other file of the plurality of files is in a format not created by the business presentation software and wherein the processing component is configured to convert the sequence of signals such that the presentation provides a seamless transition between the business presentation file and the at least one other file.

10. The presentation device of claim 7, further comprising a display device, the display device configured to receive the series of signals and display the at least one presentation.

11. The presentation device of claim 7, further comprising the memory device, wherein the memory device is at least one of the following: removable and not removable.

12. The presentation device of claim 7, the viewable image is accompanied by an audio signal.

13. The presentation device of claim 7, wherein the processing component is further configured to facilitate performance of a software update of the presentation device.

14. A mobile presentation device that is configured for coupling to a display device, the presentation device comprising:
a port configured to receive a memory device, the memory device including at least one presentation configured as a plurality of files, at least two of the plurality of files being configured in different formats; and
a processing component configured to perform at least the following:
upon receiving the memory device, automatically convert the plurality of files from the different formats into a sequence of signals;
determine whether the at least one presentation is configured as a multi-device presentation;
in response to a determination that the at least one presentation is a multi-device presentation, determine a device identifier associated with communications with a remote control unit and provide the sequence of signals for display according to the communications with the remote control unit.

15. The presentation device of claim 14, wherein the memory device includes at least one configuration file, the at least one configuration file configured to provide at least the following information: a file order for the at least one presentation, at least one security protocol, and at least one parameter for the multi-device presentation.

16. The presentation device of claim 14, wherein at least one of the plurality of files is a business presentation file created with business presentation software and at least one other file of the plurality of files is in a format not created by the business presentation software and wherein the processing component is configured to convert the sequence of signals such that the presentation provides a seamless transition between the business presentation file and the at least one other file.

17. The presentation device of claim 14, further comprising a display device, the display device configured to receive the sequence of signals and display the at least one presentation.

18. The presentation device of claim 14, further comprising the memory device, wherein the memory device is at least one of the following: removable and not removable.

19. The presentation device of claim 14, wherein the processing component is further configured to facilitate performance of a software update of the presentation device.

20. A system, comprising:
a first presentation device configured to convert at least one first file into a first plurality of first slides of a slideshow; and
a remote control unit configured to receive configuration information that includes data regarding the plurality of first slides the remote control unit further configured to control advancement of the plurality of first slides according to the configuration information.

21. The system of claim 20, further comprising a second presentation device configured to convert at least one second file into a plurality of second slides of the slideshow, wherein the configuration information includes data regarding the plurality of second slides, and wherein the remote control unit is further configured to control advancement of the plurality of second slides according to the configuration information.

22. The system of claim 21, wherein the configuration information further includes at least one of the following: timing information regarding advancement of the plurality of first slides, timing information regarding advancement of the plurality of second slides, a display order of the plurality of first slides and the plurality of second slides, an identifier associated with the first presentation device, and an identifier associated with the second presentation device.

23. The system of claim 20, wherein the remote control unit includes a communications port configured to received the configuration information via at least one of the following: a wireless connection to a computer and a wired connection to a computer.

24. The system of claim 20, wherein the remote control unit includes an automatic setting for automatically advancing through the first plurality of slices without user input.

25. The system of claim 20, wherein the remote control unit includes a manual setting for advancing through the first plurality of slices and in response to user input.

26. The system of claim 20, further comprising a display device configured to display the slideshow.
